(19) United States
(12) Patent Application Publication
(10) Pub. No.: US 2016/0150294 A1
(43) Pub. Date: May 26, 2016

(54) Video Content Metadata for Enhanced Video Experiences

(71) Applicant: Adobe Systems Incorporated, San Jose, CA (US)

(72) Inventor: Anand Prakash Phatak, San Jose, CA (US)

(21) Appl. No.: 14/549,471

(22) Filed: Nov. 20, 2014

(51) Int. Cl. H04N 21/81; H04N 21/235; H04N 21/44; H04N 21/84; H04N 21/431; H04N 21/414; G08B 6/00; H04N 21/234; H04N 21/4784; H04N 21/435; H04N 21/41

(52) U.S. Cl. CPC H04N 21/8133; H04N 21/435; H04N 21/2353; H04N 21/44008; H04N 21/84; H04N 21/4122; H04N 21/4126; H04N 21/41407; H04N 21/812; G08B 6/00; H04N 21/23424; H04N 21/44016; H04N 21/4784; H04N 21/4312

(57) ABSTRACT

In embodiments of video content metadata for enhanced video experiences, metadata can be added to video content of a video prior to distribution of the video content to client devices, where the metadata is added along a video timeline coinciding with events that occur in the video when subsequently displayed for viewing. A client device can receive the video content from a distribution service and a video software component detects the metadata in the video content as the video content is being received for playback by the client device. The metadata can then be broadcast to additional devices via a wireless communication link, where an additional device receives the metadata and initiates an action that coincides with the event that occurs in the video and to enhance a viewing experience of the playback of the video content by the client device.

### BACKGROUND

A second screen experience can be implemented for an enhanced user experience when watching television programs, movies, sporting events, and other programming. Generally, a user may be watching a sporting event on a television device while simultaneously receiving player stats and other information that correlates to the sporting event on a portable device, such as displayed on a mobile phone or tablet device (e.g., referred to as a “second screen” device). However, conventional techniques that attempt a seamless user experience are difficult to implement, and can be technologically deficient. One such second screen experience technique is based on acoustic fingerprinting, which utilizes a microphone to detect audio of the content that a user is watching on a television device, and then an application on the second screen device samples the audio of the content and generates its digital fingerprint. The application can then query an on-line service with the digital fingerprint to find a content match, and if a match is found, the on-line service responds with the additional data or information that correlates to the content the user is viewing on the television device.

However, processing delays with acoustic fingerprinting is problematic, and delays the additional data or information being displayed on the second screen device. Any ambient noise that may be present around the television device (e.g., the “first screen” device) can hamper digital fingerprint generation, resulting in a frustrating user experience. Further, it is difficult to create acoustic fingerprints of live programs and make the additional data and information available to the second screen device without introducing a substantial lag between viewing live television and displaying the additional data or information at the second screen device. Further, there is an additional step to pre-process the video content when hosting it on-line and generating a database of acoustic fingerprints for all of the content that users may view. This requires specialized software and is a time consuming process. Additionally, the database of acoustic fingerprints needs to be made available to the applications on the second screen devices, and not all applications will have permissions to access the database.

Another second screen experience technique is based on quick response (QR) code scanning, where the first screen device displays a QR code in the program broadcast containing details about the program. The user of the second screen device can scan the QR code, and an application on the second screen device decodes the QR code to display the additional content. However, QR code scanning also does not offer a seamless user experience because the user has to manually scan the QR code on the first screen device by using a camera of the second screen device, and QR codes can contain only limited data.

### SUMMARY

This Summary introduces features and concepts of video content metadata for enhanced video experiences, which is further described below in the Detailed Description and/or shown in the Figures. This Summary should not be considered to describe essential features of the claimed subject matter, nor used to determine or limit the scope of the claimed subject matter.

Video content metadata for enhanced video experiences is described. In embodiments, metadata can be added to video content of a video prior to distribution of the video content to client devices, where the metadata is added along a video timeline coinciding with events that occur in the video when subsequently displayed for viewing. A client device can receive the video content from a distribution service and a video software component detects the metadata in the video content as the video content is being received for playback by the client device. The metadata can then be broadcast to additional devices via a wireless communication link, where an additional device receives the metadata and initiates an action that coincides with the event that occurs in the video and to enhance a viewing experience of the playback of the video content by the client device.

In implementations, an additional device receives the metadata that is broadcast via the wireless communication link (e.g., via Wi-Fi or Bluetooth™) and initiates the action of displaying information that correlates to the event as it occurs in the video. For example, the event that occurs in the video may be an advertisement, the metadata that has been added to the video content correlates to the advertisement, and the additional device initiates the action to display information about a subject of the advertisement. Alternatively or in conjunction, an additional device receives the metadata that is broadcast via the wireless communication link and initiates the action of providing a haptic feedback that correlates to the event as it occurs in the video. For example, the event that occurs in the video may be a visual effect, the metadata that has been added to the video content correlates to the visual effect, and the additional device initiates the action to provide a haptic feedback that correlates to the visual effect as it occurs in the video.

In implementations, the haptic feedback can include lighting activated, a motion or vibration activation, or an environmental effect, such as a representation of a mist, breeze, or wind. Additionally, the metadata that is added to the video content may include an intensity designation that designates an intensity of the haptic feedback provided by the additional device. In some cases, an additional device may receive the metadata that is broadcast via the wireless communication link and initiate the action to cancel a haptic feedback based on a timing latency between playback of the video content by the client device and receiving the metadata via the wireless communication link.

### BRIEF DESCRIPTION OF THE DRAWINGS

Embodiments of video content metadata for enhanced video experiences are described with reference to the following Figures. The same numbers may be used throughout to reference like features and components that are shown in the Figures:

FIG. 1 illustrates an example system in which embodiments of video content metadata for enhanced video experiences can be implemented.

FIG. 2 illustrates an example table of haptic feedback commands that may be included in video content metadata for enhanced video experiences in accordance with one or more embodiments of the techniques described herein.

FIG. 3 illustrates example methods of video content metadata for enhanced video experiences in accordance with one or more embodiments of the techniques described herein.

FIG. 4 illustrates example methods of video content metadata for enhanced video experiences in accordance with one or more embodiments of the techniques described herein.

FIG. 5 illustrates an example system with an example device that can implement embodiments of video content metadata for enhanced video experiences.

### DETAILED DESCRIPTION

Embodiments of video content metadata for enhanced video experiences are described, and the techniques provide a framework for enhanced video viewing experiences by displaying additional content on a second screen device that is in sync with video content being played back on a first screen device. Prior to distribution of video content, such as gaming content, television programming, movies, video-on-demand content, and the like to client devices, metadata can be added to the video content, where the metadata is added along a video timeline coinciding with events that occur in the video when subsequently displayed for viewing. A client device (e.g., a first screen device) can receive the video content from a distribution service and the metadata that has been added to the video content can be detected. The metadata is then broadcast to additional devices (e.g., second screen devices) via Wi-Fi network communications or utilizing Bluetooth™ technology, and the additional devices initiate actions that coincide with the events that occur in the video content and to enhance a viewing experience of the playback of the video content by a client device.

The second screen devices can seamlessly discover and connect with the first screen devices, and discover the content being played back on the first screen devices through the metadata that is broadcast by a first screen device. A second screen device parses the metadata and displays the additional content or information, thus providing an enhanced viewing experience. Alternatively or in addition, a second device may be a haptic feedback device that parses the metadata and provides a haptic feedback coinciding with a special effect or other action that occurs in the video content being displayed at a first screen device.

In an example, a user may be watching an on-demand or live broadcast of a TV program episode on a first screen device, such as a smart TV, desktop computer, tablet device, mobile phone, gaming console, streaming media player, or other type of media playback device. The video stream of the program contains metadata for the program such as its genre, intended audience, ratings, etc. The first screen device broadcasts this metadata on a Wi-Fi network and the second screen devices on the same Wi-Fi network receive the metadata. Applications on the second screen devices then process the metadata and display additional data, information, and details about the program, such as information about the cast, the name of the director, year of release, recommendations to the user based on his or her profile, related advertisements, and any other type of additional information.

In another example, a user may be watching an on-demand or live video program on a first screen device, and the video stream contains metadata about advertisements that have been inserted in the program. When the video player of the first screen device detects the metadata, the metadata is broadcast to the connected second screen devices via the Wi-Fi network. The second screen devices can then process the metadata and take further action to display additional information about the product being advertised and/or generate coupons. The user may then take the mobile phone to a retailer at a later time and make a purchase using a generated coupon, and an identifier or other type of tracking code embedded in the coupon marks a sales conversion.

The second screen experiences can be extended to many other situations, such as for social network participation where a second screen device displays social networking feeds as a live program progresses on the first screen device. In a sports broadcasting example, the metadata that is embedded in the sports video content offers alternative content that can be displayed on a second screen device, such as other camera angles, unseen moments, commentary in another language, live scores, etc.

The techniques described herein may also be utilized to provide haptic feedback, such as by broadcasting the haptic feedback metadata to peripheral devices that can respond with a haptic feedback, such as during video playback or during a gaming session. For example, a 4-D multimedia experience can be created with physical effects that occur in the environment surrounding the video player, in synchronization with the content being played back on the video player or during the gaming session. During content playback, the video player broadcasts the haptic feedback metadata to the peripheral devices in the same Wi-Fi network, and the peripheral devices provide the haptic feedback as an out-of-screen realistic experience for the user. For example, a 4-D multimedia experience may be implemented with haptic feedback devices that include lighting devices, motion or vibration devices, and/or environmental devices, such as breeze or wind generating devices (e.g., fans), and mist or rain generating devices (e.g., a fog machine, water sprinklers, etc.). The haptic feedback devices for a 4-D multimedia experience may also include smell creators, noise or other audio devices, and any other type of haptic feedback devices that can be implemented to produce a realistic multimedia experience for gaming, movie watching, television viewing, and the like.

While features and concepts of video content metadata for enhanced video experiences can be implemented in any number of different devices, systems, networks, environments, and/or configurations, embodiments of video content metadata for enhanced video experiences are described in the context of the following example devices, systems, and methods.

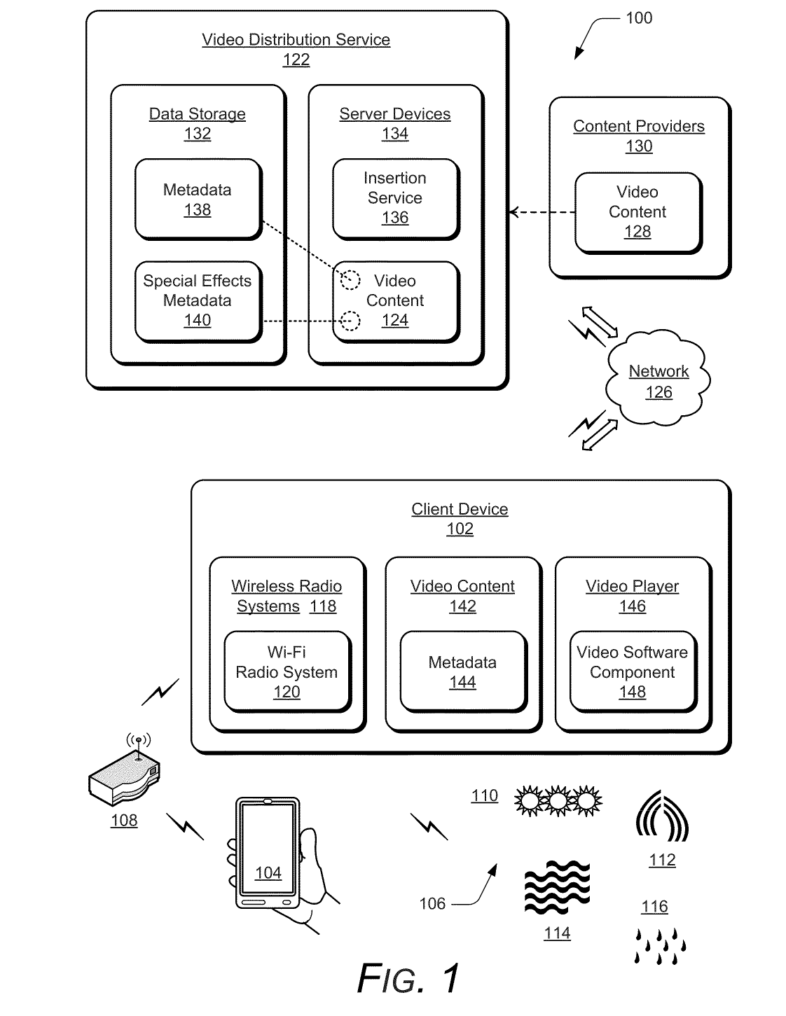

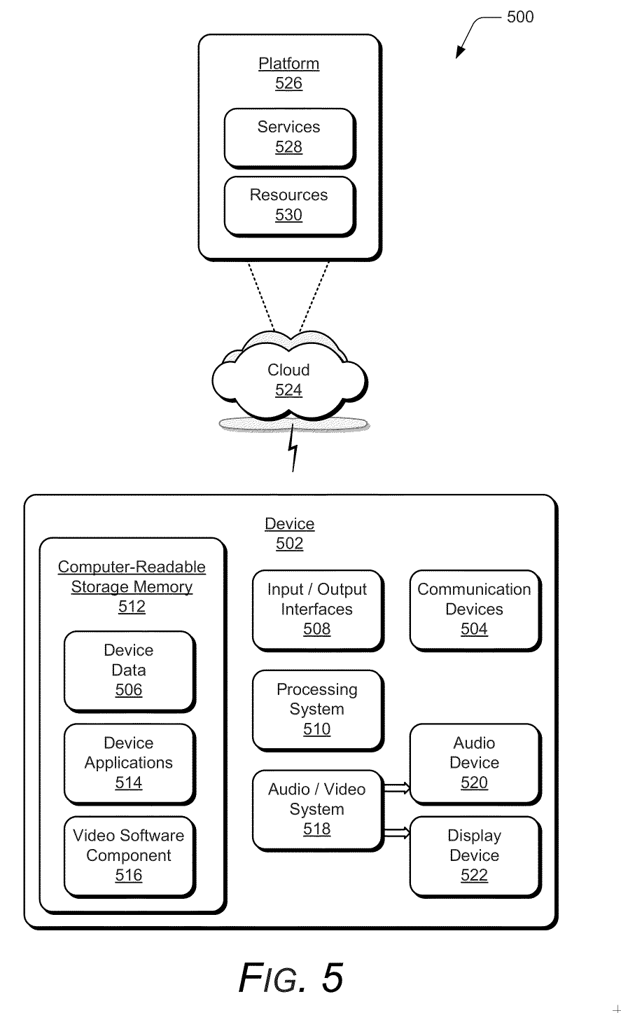

FIG. 1 illustrates an example system 100 in which embodiments of video content metadata for enhanced video experiences can be implemented. The example system 100 includes a client device 102 (also referred to herein as a first device), such as any type of computer, mobile phone, tablet device, media playback device, or other computing, communication, gaming, entertainment, and/or electronic media devices. The client device 102 can be implemented with various components, such as a processing system and memory, and with any number and combination of differing components as further described with reference to the example device shown in FIG. 5. The example system 100 also includes an additional device 104 (also referred to herein as a second device), as well as any type of haptic feedback devices 106 that are implemented to communicate with the client device 102 via a Wi-Fi access point 108.

Although shown as a mobile phone, the additional device 104 may be implemented as any type of computing or client device, such as described with reference to the client device 102. Further, although only two computing devices are shown in this example (i.e., the client device 102 and the additional device 104), the additional device 104 is representative of one or multiple different devices, and is identified as an additional device simply for convenience of discussion to differentiate between the client device and the additional device. Further still, the haptic feedback devices 106 may also be implemented with various components, such as a processing system and memory, and with any number and combination of differing components as further described with reference to the example device shown in FIG. 5. In implementations, the haptic feedback devices 106 can include lighting devices 110, motion or vibration devices 112, and/or environmental devices, such as breeze or wind generating devices 114 (e.g., fans), and mist or rain generating devices 116 (e.g., a fog machine, water sprinklers, etc.). The haptic feedback devices 106 may also include smell creators, noise or other audio devices, and any other type of haptic feedback devices that can be implemented to produce a realistic multimedia experience for gaming, movie watching, television viewing, and the like.

The client device 102 can include different wireless radio systems 118, such as for such as for Wi-Fi. Bluetooth™, Mobile Broadband, etc. In this example, the client device 102 implements a Wi-Fi radio system 120, which generally includes a radio device, antenna, and chipset that is implemented for Wi-Fi wireless communications via the Wi-Fi access point 108. In implementations, any of the devices (e.g., the client device 102, additional devices 104, and/or the haptic feedback devices 106) can be implemented for Wi-Fi wireless communications via the Wi-Fi access point and/or for Bluetooth™ wireless communications. Although generally described in the context of the Wi-Fi radio system 120 for wireless communications, any of the devices may similarly implement Bluetooth™ technology for wireless communications between the devices. The Wi-Fi access point 108 can be implemented utilizing zero configuration networking that enables all of the devices to communicate with each other via the access point, such as in a home environment of a user who has several Wi-Fi enabled devices (e.g., the mobile phone, a smart television, a computer device, a gaming console, etc.). Details of the zero configuration networking, as applicable to video content metadata for enhanced video experiences, are further described below.

The example system 100 also includes a video distribution service 122 for distribution of video content 124 to client devices, such as video playback devices, gaming devices, and any other entertainment and/or media devices. The video content 124 can include live television content, recorded content, video-on-demand content, movies, gaming content, and any other type of audio, video, and/or image data that is distributed to the client devices via a network 126. For example, the video distribution service 122 may receive video content 128 as live television content or as video-on-demand content from a content provider 130 of the video content. The video distribution service 122 includes data storage 132 that may be implemented as any suitable memory, memory device, or electronic data storage for network-based data storage of the video content. In another example, the gaming content can also be produced by a non-video content service, such as a gaming console that sits in a user's living room and is connected to the same Wi-Fi network 108. This gaming console performs effectively equivalent that of the distribution service 122, but is an example of the client device 102. When the user plays a game on the gaming console, it can communicate metadata to any of the peripheral devices, such as to the additional device 104 and/or to any of the haptic feedback devices 106, such as the lighting devices 110, motion or vibration devices 112, and/or environmental devices.

The video distribution service 122 also includes server devices 134 that are representative of one or multiple hardware server devices of the video distribution service. In implementations, the video distribution service 122 also includes the video encoders and content packagers that encode and package the video content 124 for distribution, and includes advertisement servers that insert advertisements into the video content. The data storage 132 and/or the server devices 134 may include multiple server devices and applications, and can be implemented with various components, such as a processing system and memory, as well as with any number and combination of differing components as further described with reference to the example device shown in FIG. 5.

Any of the devices, servers, and/or services described herein can communicate via the network 126, such as for data communication between the client device 102, the video distribution service 122, and the server devices 134. The network can be implemented to include a wired and/or a wireless network. The network can also be implemented using any type of network topology and/or communication protocol, and can be represented or otherwise implemented as a combination of two or more networks, to include IP-based networks and/or the Internet. The network may also include mobile operator networks that are managed by a mobile network operator and/or other network operators, such as a communication service provider, mobile phone provider, and/or Internet service provider.

The video distribution service 122 implements an insertion service 136 (which may be integrated as a component of an advertisement insertion service) that is configured to insert or otherwise add metadata 138 to the video content 124 prior to distribution of the video content to client devices, such as to the client device 102. The insertion service 136 can be implemented as a software application or module, such as executable software instructions (e.g., computer-executable instructions) that are executable with the processing system of the video distribution service 122 to implement embodiments of video content metadata for enhanced video experiences. The insertion service 136 can be stored on computer-readable storage memory (e.g., the data storage 132), such as any suitable memory device or electronic data storage implemented by the video distribution service.

The insertion service 136 can add the metadata 138 along a video timeline coinciding with events that occur in the video when subsequently displayed for viewing, such as when distributed to the client device 102 for playback and viewing of the video content. For example, an event that occurs in a video may be an advertisement, and the metadata 138 that is added to the video content 124 is advertisement metadata, such as an offer code, that correlates to the advertisement. Similarly, an event that occurs in a video (e.g., a television program or an on-demand movie), or in a video game, may be a visual effect, and special effects metadata 140 that is added to the video content correlates to the visual effect.

The insertion service 136 that is implemented by the video distribution service 122 prepares the video content 124 for distribution, such as to the client device 102. The video distribution service 122 provides for the content preparation to add or insert the metadata 138 into a stream of video content 124, similar to advertisements that are inserted in the video content. The metadata 138, once distributed to the client device 102 and broadcast to one or more additional devices via the Wi-Fi access point 108, contains the information for the additional devices to initiate actions that coincide with events that occur in the video, and to enhance a viewing experience of the playback of the video content by the client device. With video metadata tags embedded in the stream of video content, the timeline-based metadata can be created for the video content. Further, the metadata 138 is not limited to just identifiers in the video content or a URL to additional information at a particular Web site. The metadata 138 can be designed for a variety of additional device experiences, and the metadata can contain information that will instruct the additional devices to initiate different actions.

For video-on-demand content, a content producer can prepare the metadata 138 for the video content 124 and insert it into the video timeline using the insertion service 136 as a manual process. This may include putting video clips together, enhancing visual effects, adding sound effects, etc. In implementations, video editing software of the insertion service 136 can include user-selectable tools to add the special effects metadata 140 to a video timeline, such as to generate motion or a vibration of a chair, flash lights, create a wind effect, etc. The special effects metadata 140 is added to the video content 124 in a format of commands that the haptic feedback devices 106 will be able to process during gaming or video playback by the client device 102. When the video content 124 is packaged at the video distribution service 122, the special effects metadata 140 can be embedded in the media files of the on-demand video content, and placed as markers in the manifest files of the streaming media.

For a live video content implementation, such as for live television received for distribution from a content provider 130, the insertion service 136 can be utilized manually to insert or add the previously prepared metadata 138 to the video content 124, or can be implemented for automated insertion of the metadata 138 into the video content. Embedding content metadata can also be automated for live programs, such as for sporting events. For both on-demand and live video content, the insertion service 136 can be automated to insert advertisements and advertisement-related metadata 138 into the feed of the video content by updating the manifest files. The metadata may include specific information, such as identifiers that could later be tracked for sales conversions when a user makes a purchase at a retailer as a result of watching an advertisement.

In embodiments, the client device 102 can receive the video content 124 from the video distribution service 122 via the network 126, which is the video content 142 at the client device 102 that includes the metadata 144 (e.g., the metadata 138, advertisement metadata, and/or the special effects metadata 140). The client device 102 implements a video player 146, such as for playback of the video content 142 at the client device. The video content can be played back for viewing as television content, gaming content, on-demand video content, etc. on an integrated display of the client device and/or communicated to an external display, such as any type of display device, smart television, and the like.

The client device 102 includes a video software component 148, which may be integrated as a component of the video player 146, or implemented as an independent software application or component on the client device 102. The video player 146 and/or the video software component 148 can be implemented as software applications or modules, such as executable software instructions (e.g., computer-executable instructions) that are executable with the processing system of the client device to implement embodiments of video content metadata for enhanced video experiences. The video player 146 and the video software component 148 can be stored on computer-readable storage memory, such as any suitable memory device or electronic data storage implemented by the client device.

In embodiments, the video software component 148 detects the metadata 144 in the video content 142 as the video content is being received for playback by the client device 102. The metadata 144 can then be broadcast to the additional devices (e.g., the additional device 104, the haptic feedback devices 106, and/or any other secondary devices) via a Wi-Fi communication link with the Wi-Fi access point 108. The metadata 144 may also be communicated via the network 126, such as over the Internet. An additional device receives the metadata 144 and initiates an action that coincides with an event that occurs in the video (e.g., a gaming video, television program, movie, etc.) and to enhance a viewing experience of the playback of the video content by the client device. For example, an event that occurs in a video may be an advertisement, the metadata 144 that has been added to the video content 142 correlates to the advertisement, and the additional device 104 initiates an action to display information about a subject of the advertisement.

Alternatively or in conjunction, a haptic feedback device 106 receives the metadata 144 that is broadcast via the Wi-Fi communication link with the Wi-Fi access point 108 and initiates an action of providing a haptic feedback that correlates to an event as it occurs in the video. For example, the event that occurs in the video may be a visual effect, the metadata 144 that has been added to the video content 142 correlates to the visual effect (e.g., the special effects metadata 140 from the video distribution service 122), and a haptic feedback device 106 initiates the action to provide a haptic feedback that correlates to the visual effect as it occurs in the video. In implementations, the haptic feedback can include lighting activated with the lighting devices 110, a motion or vibration activation with the motion or vibration devices 112, and/or an environmental effect, such as a representation of a breeze or wind with the wind generating devices 114 (e.g., a fan) or representation of a mist or rain with the mist or rain generating devices 116 (e.g., water disbursing nozzles). Additionally, the metadata 144 that is added to the video content 142 may include an intensity designation that designates an intensity of the haptic feedback provided by one or more of the haptic feedback devices 106.

As noted above, the Wi-Fi access point 108 can be implemented utilizing zero configuration networking that enables all of the devices to communicate with each other via the access point, such as in a home environment. With the abundance of home Wi-Fi networks, the access point 108 is easily configurable for the additional device 104 and the haptic feedback devices 106 to detect the client device 102, and receive the embedded metadata 144 via the Wi-Fi network. Although the zero configuration (“zeroconfig”) utility is described, other comparable technologies may be implemented, such as the Digital Living Network Alliance (DLNA), Universal Plug and Play (UPnP), and Bluetooth™ technology for wireless communications between the devices.

Utilizing zero configuration networking, the video player 146 that is implemented on the client device 102 can declare itself as a metadata broadcasting service on the local network using Multicast DNS (mDNS) technology. The local network in this example is the home environment network of devices connected for Wi-Fi communication through the access point 108. The service assumes a name that is either preconfigured in the video player application, or obtained at runtime through a Web-based application program interface (API). The service name follows a format that's suitable for zeroconfig, such as: <Instance Name>.<Service Type>.<Domain>, where <Instance Name> is the name of the service instance, which is any UTF-8 encoded Unicode string, and is intended to be human-readable. The <Service Type> is a protocol name, preceded by an underscore, followed by the host-to-host transport protocol (TCP or UDP). The <Domain> is a standard domain name, and a generic suffix “local” is recommended since the metadata publishing service (e.g., the client device 102, in this example) is meant to be made available to second screen devices (e.g., the additional devices) on the local network.

If a conflicting service with the same name is found on the local network of the Wi-Fi access point 108, the service assumes a slightly modified name to avoid a naming conflict. The algorithm to modify a name can be as simple as appending an incrementing number at the end of its predetermined <Instance Name> to arrive at a unique, non-conflicting name, or a more complex name conflict resolving algorithm can be developed. The video player 146 on the client device 102 can maintain a list of all of the connected additional devices 104 (e.g., second screen devices) and haptic feedback devices 106 based on their network socket connections to the client device. During playback of the video content 142 by the client device 102, the video player component 148 detects the metadata 144 that is embedded in the video content, and communicates it to the connected additional and/or haptic feedback devices through the network socket connections.

When a user of the additional device 104 starts a second screen experience application on the device, the additional device can use the DNS Service Discovery (DNS-SD) mechanism of zeroconfig to lookup metadata publishing services available on the local network, which allows the devices to discover a named list of services by service type in a specified domain using standard DNS queries. When a metadata publishing service (e.g., the client device 102, in this example) is located the additional device 104 can connect to the client device 102 via the Wi-Fi access point 108 either automatically, or as a result of the device user selecting an available service that is presented in a user interface. A connection is then established when both of the devices maintain a network socket connection.

The additional device 104 and/or any of the haptic feedback devices 106 can then receive the metadata 144 from the client device 102 and initiate an action to enhance a viewing experience of the playback of the video content by the client device. For example, an application of the additional device 104 can display additional content that correlates to the video content 142, such as content recommendations, details of an advertised product, social network feeds, live scores of a sporting event, and any other type of additional content. In the case of advertisements in the video content 142, the video player 146 can communicate content and advertisement related metadata 144 over the Internet to audience measurement systems to measure that a user at certain location watched the content and advertisements. The video player 146 can also generate offer codes on the client device 102 for the advertisements that are shown for viewing during playback of the video content. Details of the audience measurement services can either be embedded in the video player application, or obtained through a Web-based API at runtime.

The video software component 148 is implemented to detect the metadata 144 for haptic feedback user experiences embedded in the manifest files (e.g., the special effects metadata 140 added to the video content at the video distribution service 122). The video software component 148 can then broadcast the metadata 144 over the Wi-Fi network via the access point 108 to all of the connected devices. The metadata may not apply to the additional device 104 or to some of the haptic feedback devices 106, in which case those devices will simply ignore the metadata during playback of the video content at the client device 102. In some cases, a haptic feedback device 106 may receive the metadata 144 that is broadcast via the Wi-Fi communication link and cancel a haptic feedback based on a timing latency between playback of the video content 142 by the client device and receiving the metadata 144 via the Wi-Fi communication link.

The haptic feedback devices 106 that the metadata 144 is intended, such as a metadata instruction to turn on lights, will be received by the lighting devices 110 that then initiate the action to activate the lighting. Other haptic feedback devices 106 may be implemented with a small, single-board computer with Wi-Fi connectivity, and a microcontroller to control mechanical actuators, such as the motion and vibration devices 112 that receive and decode the metadata, and the microcontroller will accordingly control mechanical actuators to produce the haptic feedback.

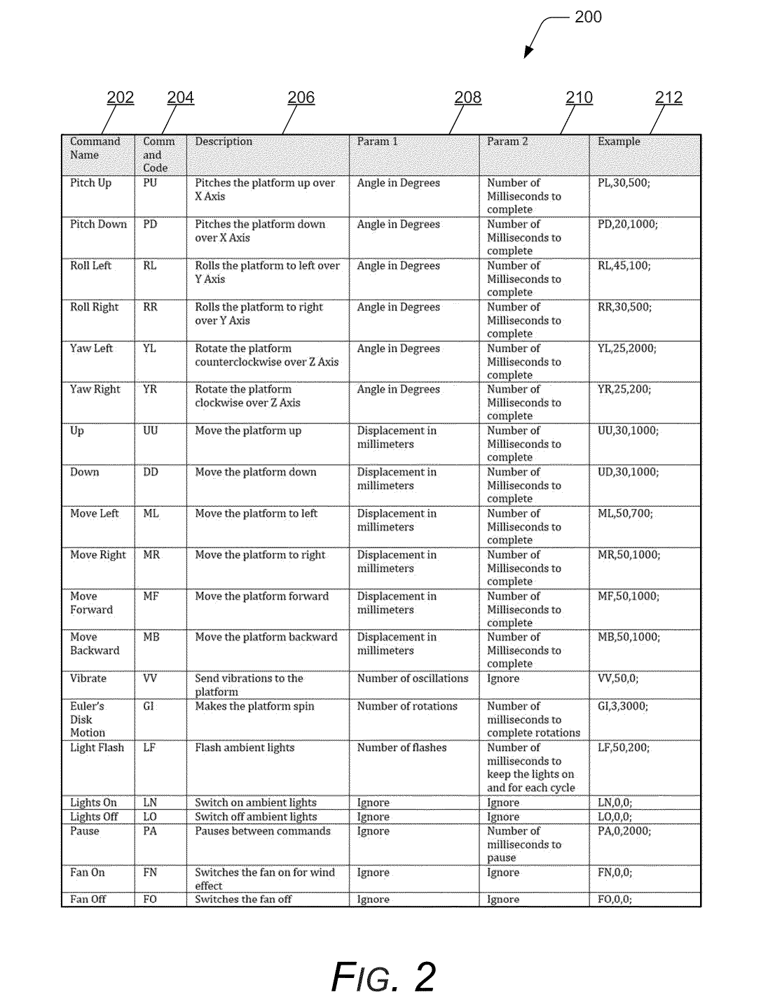

FIG. 2 illustrates an example table of haptic feedback commands 200, such as to control the motion and vibration devices 112 that are implemented with a microcontroller to control mechanical actuators and produce the haptic feedback. The haptic feedback commands 200 can be embedded in a timeline of the video content 124 by the insertion service 136 at the video distribution service 122. The haptic feedback commands 200 can be inserted in the manifest files of the streaming video, and communicated to the haptic feedback devices 106 via the Wi-Fi network by the video software component 148 at the client device 102. In this example, the haptic feedback commands 200 include command names 202 and associated command codes 204, as well as a description 206 of each command. In this example, each of the haptic feedback commands 200 also include a first parameter 208 and a second parameter 210, and an example code 212 of each haptic feedback command 200 is included in the table. The example haptic feedback commands 200 listed in the example table may be listed in different formats and can vary for different implementations, as suitable.

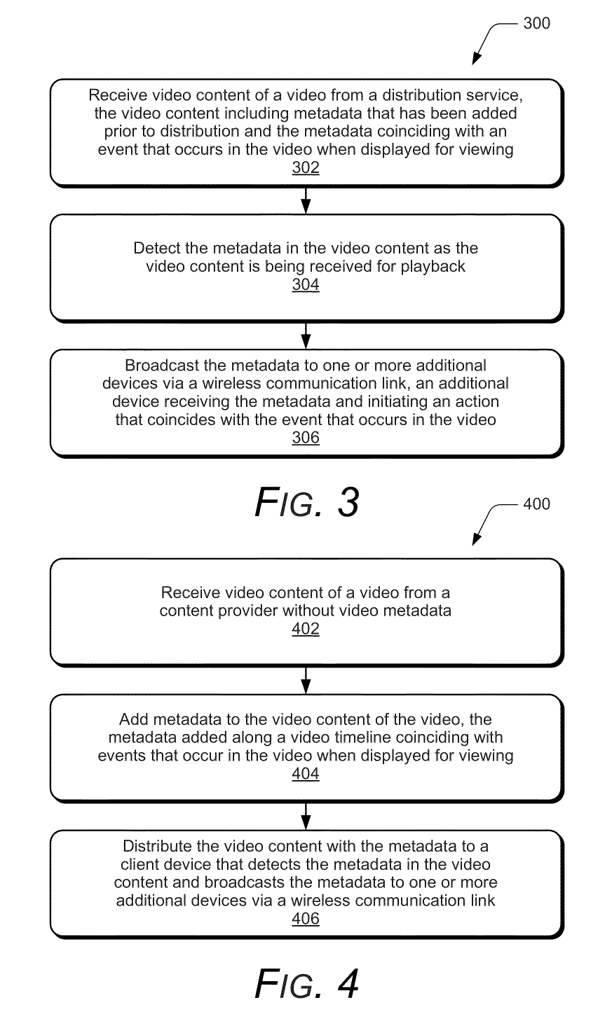

Example methods 300 and 400 are described with reference to respective FIGS. 3 and 4 in accordance with one or more embodiments of video content metadata for enhanced video experiences. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 3 illustrates example method(s) 300 of video content metadata for enhanced video experiences, and is generally described with reference to the video software component 148 that is implemented at the client device 102 as shown in the example system of FIG. 1. The order in which the method is described is not intended to be construed as a limitation, and any number or combination of the method operations can be combined in any order to implement a method, or an alternate method.

At 302, video content of a video is received from a distribution service, the video content including metadata that has been added prior to distribution and the metadata coinciding with an event that occurs in the video when displayed for viewing. For example, the video player 146 that is implemented at the client device 102 receives the video content 142 from the video distribution service 122 via the network 126. The video content 142 includes the metadata 144 that has been added by the insertion service 136 at the video distribution service 122 prior to distribution of the video content to the client device. The metadata 144 added to the video content 142 coincides with one or more events that occur in the video when displayed for viewing by the client device 102. The metadata 144 that is added to the video content 142 can also include an intensity designation that designates an intensity of a haptic feedback provided by one or more of the haptic feedback devices 106.

At 304, the metadata in the video content is detected as the video content is being received for playback. For example, the video software component 148 that is implemented at the client device 102 detects the metadata 144 in the video content 142 as the video content is being received from the video distribution service 122.

At 306, the metadata is broadcast to one or more additional devices via a wireless communication link, where an additional device receives the metadata and initiates an action that coincides with the event that occurs in the video. For example, the metadata 144 that is detected in the video content 142 at the client device 102 is broadcast by the Wi-Fi radio system 120 of the client device, or via Bluetooth™ technology, to the additional devices 104 and to the haptic feedback devices 106. Any of the additional devices 104 and/or haptic feedback devices 106 receive the metadata 144 and initiate an action to enhance a viewing experience of the playback of the video content 102 by the client device 102.

In implementations, the additional device 104 initiates the action of displaying information that correlates to an event as it occurs in the video. For example, the event that occurs in the video is an advertisement, the metadata 144 correlates to the advertisement, and the additional device 104 displays information about a subject of the advertisement. Alternatively, a haptic feedback device 106 initiates an action of providing a haptic feedback that correlates to the event as it occurs in the video. For example, the event that occurs in the video is a visual effect, the metadata 144 correlates to the visual effect, and a haptic feedback device 106 provides a haptic feedback that correlates to the visual effect as it occurs in the video. The haptic feedback can include one or more of lighting activated, a motion activation, or an environmental effect (e.g., a water or mist spray, or a simulated breeze).

FIG. 4 illustrates example method(s) 400 of video content metadata for enhanced video experiences, and is generally described with reference to the video distribution service 122 and the insertion service 136 as shown in the example system of FIG. 1. The order in which the method is described is not intended to be construed as a limitation, and any number or combination of the method operations can be combined in any order to implement a method, or an alternate method.

At 402, video content of a video is received from a content provider without video metadata. For example, the video distribution service 122 receives the video content 128 as live television content or video-on-demand content from a content provider 130 of the video content, and the video content is received without video metadata, such as video of a live television event or program. In implementations, the video distribution service 122 is implemented for distribution of the video content 124 to client devices, such as video playback devices, gaming devices, and any other entertainment and/or media devices. The video content 124 can include live television content, movies, recorded content, video-on-demand content, gaming content, and any other type of audio, video, and/or image data that is distributed to the client devices via the network 126.

At 404, metadata is added to the video content of the video, where the metadata is added along a video timeline coinciding with events that occur in the video when displayed for viewing. For example, the insertion service 136 that is implemented at the video distribution service 122 adds the metadata 138 and/or the special effects metadata 140 to the video content 124, where the metadata is added along a video timeline coinciding with events that occur in the video when subsequently displayed for viewing after distribution of the video content to the client device 102. In implementations, the metadata 138 and/or the special effects metadata 140 is added to the video content 124 either automatically or manually as the video content is received from a content provider 130 and before the video content is distributed for playback at the client device.

At 406, the video content is distributed with the metadata to a client device that detects the metadata in the video content and broadcasts the metadata to one or more additional devices via a wireless communication link. For example, a server device 134 of the video distribution service 122 distributes the video content 124 with the metadata 138 and/or the special effects metadata 140 to the client device 102 via the network 126, where the video software component 148 detects the metadata 144 in the video content 142 and communicates the video content to the additional devices 104 and/or to the haptic feedback devices 106 via the Wi-Fi access point 108 and/or via Bluetooth™ technology. The additional devices 104 and/or to the haptic feedback devices 106 receive the metadata 144 and enhance a viewing experience during playback of the video content 142 at the client device by initiating actions that coincide with the events that occur in the video.

FIG. 5 illustrates an example system 500 that includes an example device 502, which can implement embodiments of video content metadata for enhanced video experiences. The example device 502 can be implemented as any of the computing devices and/or services (e.g., server devices) described with reference to the previous FIGS. 1-4, such as any type of computing device, client device, mobile phone, tablet, communication, entertainment, gaming, media playback, and/or other type of device. For example, the client device 102, the additional device 104, the haptic feedback devices 106, and/or the server devices 134 shown in FIG. 1 may be implemented as the example device 502.

The device 502 includes communication devices 504 that enable wired and/or wireless communication of device data 506, such as video content and metadata that is transferred from one computing device to another, and/or synched between multiple computing devices. The device data can include any type of audio, video, and/or image data, such as video content and metadata that is generated by applications executing on the device. The communication devices 504 can also include transceivers for cellular phone communication and/or for network data communication.

The device 502 also includes input/output (I/O) interfaces 508, such as data network interfaces that provide connection and/or communication links between the device, data networks, and other devices. The I/O interfaces can be used to couple the device to any type of components, peripherals, and/or accessory devices, such as a digital camera device that may be integrated with device 502. The I/O interfaces also include data input ports via which any type of data, media content, and/or inputs can be received, such as user inputs to the device, as well as any type of audio, video, and/or image data received from any content and/or data source.

The device 502 includes a processing system 510 that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The device 502 may further include any type of a system bus or other data and command transfer system that couples the various components within the device. A system bus can include any one or combination of different bus structures and architectures, as well as control and data lines.

The device 502 also includes computer-readable storage memory 512, such as data storage devices that can be accessed by a computing device, and that provide persistent storage of data and executable instructions (e.g., software applications, modules, programs, functions, and the like). Examples of computer-readable storage memory include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage memory in various memory device configurations.

The computer-readable storage memory 512 provides storage of the device data 506 and various device applications 514, such as an operating system that is maintained as a software application with the computer-readable storage memory and executed by the processing system 510. In this example, the device applications also include a video software component 516 that implements embodiments of video content metadata for enhanced video experiences, such as when the example device 502 is implemented as the client device 102 shown in FIG. 1. An example of the video software component 516 includes the video software component 148 that is implemented by the client device 102, as described with reference to FIGS. 1-4.

The device 502 also includes an audio and/or video system 518 that generates audio data for an audio device 520 and/or generates display data for a display device 522. The audio device and/or the display device include any devices that process, display, and/or otherwise render audio, video, display, and/or image data, such as the image content of a digital photo. In implementations, the audio device and/or the display device are integrated components of the example device 502. Alternatively, the audio device and/or the display device are external, peripheral components to the example device. In embodiments, at least part of the techniques described for video content metadata for enhanced video experiences may be implemented in a distributed system, such as over a “cloud” 524 in a platform 526. The cloud 524 includes and/or is representative of the platform 526 for services 528 and/or resources 530. For example, the services 528 may include the video distribution service 122 described with reference to FIGS. 1-4.

The platform 526 abstracts underlying functionality of hardware, such as server devices (e.g., included in the services 528) and/or software resources (e.g., included as the resources 530), and connects the example device 502 with other devices, servers, etc. The resources 530 may also include applications and/or data that can be utilized while computer processing is executed on servers that are remote from the example device 502. Additionally, the services 528 and/or the resources 530 may facilitate subscriber network services, such as over the Internet, a cellular network, or Wi-Fi network. The platform 526 may also serve to abstract and scale resources to service a demand for the resources 530 that are implemented via the platform, such as in an interconnected device embodiment with functionality distributed throughout the system 500. For example, the functionality may be implemented in part at the example device 502 as well as via the platform 526 that abstracts the functionality of the cloud 524.

Although embodiments of video content metadata for enhanced video experiences have been described in language specific to features and/or methods, the appended claims are not necessarily limited to the specific features or methods described. Rather, the specific features and methods are disclosed as example implementations of video content metadata for enhanced video experiences.

1. A method, comprising:
receiving video content of a video from a distribution service, the video content including metadata that has been added prior to distribution and the metadata coinciding with an event that occurs in the video when displayed for viewing at a first device;
detecting the metadata in the video content as the video content is being received for playback by the first device; and
broadcasting the metadata to at least a second device via a wireless communication link, the second device receiving the metadata and initiating an action that coincides with the event that occurs in the video.

2. The method as recited in claim 1, wherein the second device receives the metadata that is broadcast via the wireless communication link and initiates the action to enhance a viewing experience of the playback of the video content by the first device.

3. The method as recited in claim 1, wherein the second device receives the metadata that is broadcast via the wireless communication link and initiates the action of displaying information that correlates to the event as it occurs in the video.

4. The method as recited in claim 1, wherein:
the event that occurs in the video is an advertisement;
the metadata correlates to the advertisement; and
the action that is initiated comprises the second device displaying information about a subject of the advertisement.

5. The method as recited in claim 1, wherein:
the event that occurs in the video is an advertisement;
the metadata includes one of a coupon code or a tracking code that correlates to the advertisement; and
the action that is initiated comprises the second device generating a coupon that is usable at a retailer for a sales conversion.

6. The method as recited in claim 1, wherein the second device receives the metadata that is broadcast via the wireless communication link and initiates the action of providing a haptic feedback that correlates to the event as it occurs in the video.

7. The method as recited in claim 1, wherein:
the event that occurs in the video is a visual effect;
the metadata correlates to the visual effect; and
the action that is initiated comprises the second device providing a haptic feedback that correlates to the visual effect as it occurs in the video.

8. The method as recited in claim 7, wherein the haptic feedback includes one or more of lighting activated, a motion activation, or an environmental effect.

9. The method as recited in claim 7, wherein the metadata added to the video content includes an intensity designation that designates an intensity of the haptic feedback provided by the second device.

10. The method as recited in claim 1, wherein the second device receives the metadata that is broadcast via the wireless communication link and initiates the action to cancel a haptic feedback based on a timing latency between playback of the video content by the first device and receiving the metadata via the wireless communication link.

11. The method as recited in claim 1, wherein:
the second device receives the metadata that is broadcast via the wireless communication link and initiates the action of displaying information that correlates to the event as it occurs in the video; and
a third device receives the metadata that is broadcast via the wireless communication link and provides a haptic feedback that correlates to the event as it occurs in the video.

12. A client device, comprising:
a media input configured to receive video content of a video, the video content including metadata that has been added prior to distribution and the metadata coinciding with events that occur in the video when displayed for viewing;
a memory and processor system configured to execute a video software component that is implemented to:
detect the metadata in the video content as the video content is being received for playback; and
initiate a broadcast of the metadata to at least an additional device via a wireless communication link, the additional device configured to receive the metadata and enhance a viewing experience of the playback of the video content by initiating an action that coincides with at least one of the events that occur in the video.

13. The client device as recited in claim 12, wherein the additional device receives the metadata that is broadcast via the wireless communication link and initiates the action to display information that correlates to the at least one event as it occurs in the video.

14. The client device as recited in claim 12, wherein:
the at least one event that occurs in the video is an advertisement;
the metadata correlates to the advertisement; and
the action is initiated by the additional device to display information about a subject of the advertisement.

15. The client device as recited in claim 12, wherein the additional device receives the metadata that is broadcast via the wireless communication link and initiates the action to provide a haptic feedback that correlates to the at least one event as it occurs in the video.

16. The client device as recited in claim 12, wherein:
the at least one event that occurs in the video is a visual effect;
the metadata correlates to the visual effect; and
the action is initiated by the additional device to provide a haptic feedback that correlates to the visual effect as it occurs in the video.

17. A method, comprising:
receiving video content of a video from a distribution service, the video content including metadata that has been added prior to distribution and the metadata coinciding with events that occur in the video when displayed for viewing at a client device, at least one of the events being an advertisement that is displayed for viewing;
detecting the metadata in the video content as the video content is being received for playback by the client device; and
broadcasting the metadata to one or more additional devices via a wireless communication link, at least one of the additional devices receiving the metadata and generating a coupon that coincides with the advertisement occurring in the video.

18. The method as recited in claim 17, wherein the metadata includes a tracking code that is associated with the coupon, which is usable at a retailer for a sales conversion, and wherein the tracking code is communicated to an advertisement tracking service with details of the sales conversion.

19. The method as recited in claim 17, wherein at least one of the additional devices receives the metadata that is broadcast via the wireless communication link and initiates an action to enhance a viewing experience of the playback of the video content by the client device.

20. The method as recited in claim 17, wherein:
at least one of the events that occur in the video is a visual effect;
the metadata correlates to the visual effect; and
the metadata is added to the video content for distribution to the client device and subsequent broadcast to at least one of the additional devices that initiates providing a haptic feedback that correlates to the visual effect as it occurs in the video.
